(19) United States
(12) Patent Application Publication
(10) Pub. No.: US 2017/0011369 A1
(43) Pub. Date: Jan. 12, 2017

(54) NETWORK-BASED PAYMENT PROCESSOR

(71) Applicant: S Stream Capital, LLC, Austin, TX (US)

(72) Inventors: David S. Wesson, Bryan, TX (US); Omar Besim Hakim, Austin, TX (US)

(73) Assignee: S Stream Capital, LLC, Austin, TX (US)

(21) Appl. No.: 15/152,964

(22) Filed: May 12, 2016

Related U.S. Application Data
(63) Continuation-in-part of application No. 14/750,206, filed on Jun. 25, 2015, now abandoned.
Application No. 14/750,206 is a continuation of application No. 13/645,304, filed on Oct. 4, 2012, now abandoned.
(60) Provisional application No. 61/543,225, filed on Oct. 4, 2011.

(51) Int. Cl. G06Q 20/10; G06Q 40/02

(52) U.S. Cl. CPC G06Q 20/102; G06Q 40/02

(57) ABSTRACT

A system including at least one processor and a memory operates in response to a transaction on an account that is a single transaction that includes revenue, comparing, via a one or more processors, transaction data for the transaction to an algorithmic representation of an agreement between a transaction recipient and one or more parties of the agreement that supports a revenue allocation based on a determination if a payment obligation is applicable to the transaction based on the revenue, based on a date of the transaction, and further based on historical data for the account. Responsive to determining that the payment obligation is applicable to the transaction, the system calculates an allocation of funds based on the algorithmic representation of the agreement between the transaction recipient and the one or more parties of the agreement; store a record of the allocation of funds on a storage device; and automatically processes a payment to the one or more parties of the agreement, in accordance with the record of the allocation of funds.

### CROSS-REFERENCE TO RELATED APPLICATIONS

The present U.S. Utility patent application claims priority pursuant to 35 U.S.C. §120 as a continuation-in-part of U.S. Utility application Ser. No. 14/750,206, entitled “METHODS AND APPARATUS FOR ALLOCATING FUNDS BASED ON PAYMENT OBLIGATIONS”, filed Jun. 25, 2015, which is a continuation of U.S. Utility application Ser. No. 13/645,304, entitled “METHODS AND APPARATUS FOR ALLOCATING FUNDS BASED ON PAYMENT OBLIGATIONS”, filed Oct. 4, 2012, which claims priority pursuant to 35 U.S.C. §119(e) to U.S. Provisional Application No. 61/543,225, entitled “METHODS AND APPARATUS FOR TRACKING, MANAGING AND REPORTING REVENUE CAPITAL TRANSACTIONS”, filed Oct. 4, 2011, all of which are hereby incorporated herein by reference in their entirety and made part of the present U.S. Utility patent application for all purposes.

### BACKGROUND

### Field of the Invention

The present application relates to processors that operate via a network, such as the Internet, to record and process payments.

### BRIEF DESCRIPTION OF THE DRAWINGS

FIG. 1 illustrates a system architecture for tracking, managing and reporting transactions, according to some embodiments.

FIG. 2 depicts a module that that may be used for implementing tracking, managing and reporting of transactions, according to some embodiments.

FIGS. 3A-3C illustrate a series of payments that may be tracked, managed and reported in transactions, according to some embodiments.

FIG. 4 is a high-level logical flowchart of operations usable for tracking, managing and reporting revenue capital transactions, according to some embodiments.

FIG. 5A is a high-level logical flowchart of operations that can be used for calculating a payment obligation in the context of tracking, managing and reporting revenue capital transactions, according to some embodiments.

FIG. 5B is a high-level logical flowchart of operations that can be used for calculating a payment obligation in the context of tracking, managing and reporting revenue capital transactions, according to some embodiments.

FIG. 5C is a high-level logical flowchart of operations that can be used for calculating a payment obligation in the context of tracking, managing and reporting revenue capital transactions, according to some embodiments.

FIG. 6 depicts a flow-of-funds diagram illustrating an account used in some embodiments.

FIG. 7 illustrates a high-level logical flowchart of operations that can be used in conjunction with an account in some embodiments.

FIG. 8 illustrates a high-level logical flowchart of operations that can be used in conjunction with an account in some embodiments.

FIG. 9A illustrates a high-level logical flowchart of operations that can be used in conjunction with an account in some embodiments.

FIG. 9B illustrates a high-level logical flowchart of operations that can be used in conjunction with an account in some embodiments.

FIG. 9C illustrates a high-level logical flowchart of operations that can be used in conjunction with an account in some embodiments.

FIG. 9D illustrates a high-level logical flowchart of operations that can be used in conjunction with an account and payment determination data, in some embodiments.

FIG. 10A illustrates a high-level logical flowchart of operations that can be used in conjunction with an account in some embodiments.

FIG. 10B illustrates a high-level logical flowchart of operations that can be used in conjunction with an account in some embodiments.

FIG. 10C illustrates a high-level logical flowchart of operations that can be used in conjunction with an account in some embodiments.

FIG. 10D illustrates a high-level logical flowchart of operations that can be used in conjunction with an account in some embodiments.

FIG. 11A illustrates a high-level logical flowchart of operations that can be used in conjunction with an account in some embodiments.

FIG. 11B illustrates a high-level logical flowchart of operations that can be used in conjunction with an account in some embodiments.

FIG. 12 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean “including, but not limited to”.

### DETAILED DESCRIPTION OF EMBODIMENTS

Some embodiments provide methods and apparatus for allocating funds based on payment obligations. Some such embodiments provide support for managing compliance with agreed financial obligations. In various contexts, non-limiting examples of which range from the management of real estate financing to child support payments, embodiments support managing, tracking, reporting and facilitating payments to comply with agreed payment obligations. In some embodiments, in response to a transaction on an account, transaction data for the transaction is compared to one or more transaction rules to determine if a payment obligation is applicable to the transaction. In some embodiments, the transaction rules provide an algorithmic representation of an agreement between a transaction recipient and one or more parties of the agreement. Responsive to determining that the payment obligation is applicable to the transaction, an allocation of funds based on the algorithmic representation of the agreement between the transaction recipient and the one or more parties of the agreement, is calculated. A record of the allocation of funds is stored on a storage device.

Some embodiments provide methods and apparatus for facilitating the refinancing of real estate loans are disclosed. In some embodiments, a loan-to-value ratio is calculated. Responsive to the loan-to-value ratio being greater than a allowed loan-to-value threshold in a refinancing of the real estate loan, a value of paydown capital required to create a refinance loan-to-value ratio for a refinance loan that is less than or equal to the allowed loan-to-value threshold is calculated. Paydown capital equal to the value of paydown capital required to create the refinance loan-to-value ratio less than or equal to the allowed loan-to-value threshold is provided under revenue-capital repayment terms. In some embodiments, the loan-to-value ratio includes a function of a balance owed on a real estate loan, and a re-appraised property value of a property associated with the real estate loan.

### Brief Explanation of Technical Terms

In the Following Detailed Description, Numerous Specific Details are Set Forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While some processes or operations described herein are described as being performed by a particular module or modules, one of skill in the art will readily discern in light of having read the present disclosure that such operations or process may be performed by other modules or that modules and their functions may be distributed to computing systems other than those shown (e.g., executing on a client while shown herein on a server) without departing from the scope and intent of the present disclosure. Likewise, while some process are presented as a series of operations and are explained in a particular order, one of skill in the art will readily discern in light of having read the present disclosure that such operations or processes may be performed in an alternative order or combination without departing from the scope and intent of the present disclosure. Embodiments will combine, omit, and substitute modules and the operations that they perform or execute without departing from the scope and intent of the present disclosure. In the discussion contained herein, embodiments are described as performing operations, transactions, financial transactions or procedures, which may be taken to mean both performing an operation or procedure directly or supporting that operation or procedure through the processing or preparation of data for that operation or procedure. Likewise, as used herein, performing includes transmitting data or preparing data for transmission to another device for performance of the operation.

While a processor is generally understood to mean a microprocessor or other computing apparatus, some embodiments of the present invention support human processing (e.g., pen and paper recording and allocating) to execute the steps described. Some embodiments may be implemented by a computer processor supporting human intervention and non-transitory media, such as a human processor using a computer, the Internet, a website, a smartphone or calculator to assist with pen and paper recording and allocating or computer-based recording and allocating. In some embodiments, a hybrid approach, such as crowd sourcing of a distributed task using a microprocessor based supervision system and a plurality of human processors (e.g., Amazon.com Mechanical Turk™) may perform the operations described herein.

### Introduction to Revenue Capital

Various embodiments of methods and apparatus for tracking, managing and reporting revenue capital transactions are disclosed. Revenue Capital (RC) is business financing based primarily on the sale or exchange of revenue streams. RC includes royalty-based financing, top-line income rights and a variety of other revenue-centric funding structures.

For example, an RC investor may provide a business unit with $250K in exchange for 3% of the gross revenue of the business unit over a specified period of time, or until a specific payback amount is received. Regardless of the specific deal terms, RC encompasses funding structures where future revenue is the primary means of repayment. In some embodiments, revenue capital transactions function without the use of balance-sheet debt or traditional equity. In some embodiments, payments are divided between return to capital and a patent royalty, as described below.

Some embodiments may include a method for tracking, managing and reporting revenue capital transactions. In some embodiments, one or more processors are employed to perform calculating a payment obligation. The calculating the payment obligation includes allocating a payment portion to a return of capital, and allocating another payment portion to an agreed royalty payment.

In some embodiments, payment determination data is received. The calculating the payment obligation further includes determining an amount of a current payment based at least in part upon a value derived from the payment determination data. In some embodiments, the calculating the payment obligation includes calculating a value or set of values of a payment or series of payments under a contract for an advance of capital and license of intellectual property.

In some embodiments, the allocating the payment portion further includes allocating a portion of one or more payments addressable to the payment obligation. In some embodiments, payment of the payment obligation is ascertained and a next balance of a capital account is calculated. In some embodiments, the payment obligation is a series of payments. A first group of payments from the series of payments is applied entirely toward the return of capital until retirement, and a second group of payments from the series of payments is applied entirely toward the agreed royalty payment.

In some embodiments, the payment obligation is a series of payments. A first group of payments from the series of payments is applied entirely toward the agreed royalty payment, and a second group of payments from the series of payments is applied entirely toward the return of capital until retirement. In some embodiments the payment obligation is a series of payments. A portion of each payment is allocated to the agreed royalty payment. Another portion of each payment is allocated to the return to capital. A ratio between the portion and the another portion is fixed across the series of payments until the retirement of the obligation. In some embodiments the payment obligation is a series of payments. A portion of each payment is allocated to the agreed royalty payment. Another portion of each payment is allocated to the return to capital. A ratio between the portion and the another portion that is variable across the series of payments in response to agreed-upon terms.

Some embodiments may include a means for tracking, managing and reporting revenue capital transactions, which may include means for calculating a payment obligation. In some embodiments, the means for calculating the payment obligation includes means for allocating a payment portion to a return of capital, and allocating another payment portion to an agreed royalty payment. Some embodiments further include means for receiving payment determination data, as described herein. In some embodiments, the means for calculating the payment obligation further comprises means for determining an amount of a current payment based at least in part upon a value derived from the payment determination data. Some embodiments further include means for reporting data and preparing reports related to the payment obligation and payments made in fulfillment of the payment obligation. In some embodiments, such reporting includes reporting of the transactions with characterization for meeting revenue service tax accounting requirements and reporting requirements. Specifically, some embodiments provide detail to meet requirements of revenue service reporting for capital gains tax treatment on royalty payments for a patent. Further, some embodiments enable any accounting system service provider sublicensor or their institutional partners and the clients of either type of entity to track, collect, report and manage revenue reporting for capital gains tax treatment on royalty payments under contractual terms.

Some embodiments may include a transaction management module for tracking, managing and reporting revenue capital transactions. The transaction management module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform calculating a payment obligation. In some embodiments, the instructions for calculating the payment obligation include instructions for allocating a payment portion to a return of capital, and allocating another payment portion to an agreed royalty payment. Some embodiments further include instructions for reporting data and preparing reports related to the payment obligation and payments made in fulfillment of the payment obligation. Some embodiments further include instructions within the transaction management module for receiving payment determination data. In some embodiments, the instructions for calculating the payment obligation further include instructions for determining an amount of a current payment based at least in part upon a value derived from the payment determination data. Other embodiments of the transaction management module may be at least partially implemented by hardware circuitry and/or firmware stored, for example, in a non-volatile memory.

### Introduction to Account Embodiments

Some embodiments may include a method for allocating funds based on payment obligations. In some embodiments, the method includes performing, using one or more processors, in response to a transaction on an account, comparing transaction data for the transaction to one or more transaction rules to determine if a payment obligation is applicable to the transaction, responsive to determining that the payment obligation is applicable to the transaction, calculating an allocation of funds based on the algorithmic representation of the agreement between the transaction recipient and the one or more parties of the agreement, and storing a record of the allocation of funds on a storage device. In some embodiments, the transaction rules provide an algorithmic representation of an agreement between a transaction recipient and one or more parties of the agreement.

In some embodiments, the calculating the allocation of funds based on the algorithmic representation of the agreement between the transaction recipient and the one or more parties of the agreement further includes calculating a payment portion allocated to a return of capital, and another payment portion allocated to an agreed royalty payment. In some embodiments, the calculating the allocation of funds based on the algorithmic representation of the agreement between the transaction recipient and the one or more parties of the agreement further includes calculating the allocation of funds based on the algorithmic representation of the agreement between the transaction recipient and the one or more parties of the agreement based at least in part on a date of the transaction.

In some embodiments, the calculating the allocation of funds based on the algorithmic representation of the agreement between the transaction recipient and the one or more parties of the agreement further includes calculating the allocation of funds based on the algorithmic representation of the agreement between the transaction recipient and the one or more parties of the agreement based at least in part on a percentage allocation of the transaction reflected in the algorithmic representation of the agreement between the transaction recipient and the one or more parties of the agreement.

In some embodiments, the calculating the allocation of funds based on the algorithmic representation of the agreement between the transaction recipient and the one or more parties of the agreement further includes calculating the allocation of funds based on the algorithmic representation of the agreement between the transaction recipient and the one or more parties of the agreement based at least in part on an amount of the transaction. In some embodiments, the comparing transaction data for the transaction to one or more transaction rules further comprises comparing transaction data for the transaction and historical data for the account to one or more transaction rules. In some embodiments, the method further includes facilitating a payment to the one or more parties of the agreement. In some embodiments, the method further includes generating a report based on the allocation of funds, wherein the report provides instructions for performing a payment.

Some embodiments may include a means for allocating funds based on payment obligations. For example, a transaction management module may perform, in response to a transaction on an account, comparing transaction data for the transaction to one or more transaction rules to determine if a payment obligation is applicable to the transaction, responsive to determining that the payment obligation is applicable to the transaction, calculating an allocation of funds based on the algorithmic representation of the agreement between the transaction recipient and the one or more parties of the agreement, and storing a record of the allocation of funds on a storage device, as described herein. The transaction management module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform in response to a transaction on an account, comparing transaction data for the transaction to one or more transaction rules to determine if a payment obligation is applicable to the transaction, responsive to determining that the payment obligation is applicable to the transaction, calculating an allocation of funds based on the algorithmic representation of the agreement between the transaction recipient and the one or more parties of the agreement, and storing a record of the allocation of funds on a storage device, as described herein. Other embodiments of the transaction module may be at least partially implemented by hardware circuitry and/or firmware stored, for example, in a non-volatile memory.

### Introduction to Real-Estate Embodiments

Some embodiments may include a method for facilitating the refinancing of real estate loans. Some such embodiments may be used to address problems in refinancing real estate when the market value of the real estate—based upon a current appraisal—has fallen below the value recorded from an earlier appraisal of the same property.

As used herein, a loan to value (LTV) ratio includes but is not limited to a financial term used by commercial lenders to express the ratio of a loan underwritten to a value of an asset purchased. The term is commonly used by banks and building societies to represent the ratio of the first mortgage lien as a percentage of the total appraised value of real property. For instance, if a borrower borrows $130,000 to purchase a house worth $150,000 at a relative valuation, the LTV ratio is $130,000/$150,000 or 87%.

Loan to value is one of the key risk factors that lenders assess when qualifying borrowers for a mortgage. The risk of default is sometimes at the forefront of lending decisions, and the likelihood of a lender absorbing a loss in the foreclosure process increases as the amount of equity decreases. Therefore, as the LTV ratio of a loan increases, the qualification guidelines for certain mortgage programs become much more strict. Lenders can require borrowers of high LTV loans to buy mortgage insurance to protect the lender from the buyer default, which increases the costs of the mortgage.

The valuation of a property is typically determined by an appraiser, but there is no greater measure of the actual real value of one property than an arms-length transaction between a willing buyer and a willing seller. Typically, banks will utilize the lesser of the appraised value and purchase price if the purchase is “recent.” What constitutes recent varies by institution but is generally less than 2 years.

Low LTV ratios (below 80%) carry with them lower rates for lower-risk borrowers and allow lenders to consider higher-risk borrowers, such as those with low credit scores, previous late payments in their mortgage history, high debt-to-income ratios, high loan amounts or cash-out requirements, insufficient reserves and/or no income documentation. Higher LTV ratios are primarily reserved for borrowers with higher credit scores and a satisfactory mortgage history. The full financing, or 100% LTV, is reserved for only the most credit-worthy borrowers. Lenders are typically restricted by State and Federal (FDIC and/or OCC) regulations that limit the number of loans they may make that have LTVs above a set of defined LTV thresholds.

In some embodiments, one or more processors are employed to perform calculating a loan-to-value ratio, responsive to the loan-to-value ratio being greater than a allowed loan-to-value threshold in a refinancing of the real estate loan, calculating a value of paydown capital required to create a refinance loan-to-value ratio for a refinance loan that is less than or equal to the allowed loan-to-value threshold, and providing under revenue-capital repayment terms paydown capital equal to the value of paydown capital required to create the refinance loan-to-value ratio less than or equal to the allowed loan-to-value threshold. In some embodiments, the loan-to-value ratio includes a function of a balance owed on a real estate loan, and a re-appraised property value of a property associated with the real estate loan. As used herein, a re-appraised property value includes but is not limited to a property value assessed in preparation for a refinance, rather than in preparation for the original loan.

Real estate appraisal, property valuation or land valuation is the process of valuing real property. The value usually sought is the property's Market Value. The appraiser usually provides a written report on this value to his or her client. These reports are used as the basis for mortgage loans, for settling estates and divorces, for tax matters, and so on. Sometimes the appraisal report is used by both parties to set the sale price of the property appraised.

There are several types and definitions of value sought by a real estate appraisal. Some of the most common are:

Market value—The price at which an asset would trade in a competitive Walrasian auction setting. Market value is usually interchangeable with open market value or fair value. International Valuation Standards (IVS) define:

Market value—the estimated amount for which an asset or liability should exchange on the valuation date between a willing buyer and a willing seller in an arm's length transaction, after proper marketing and where the parties had each acted knowledgeably, prudently and without compulsion.

Value-in-use, or use value—The net present value (NPV) of a cash flow that an asset generates for a specific owner under a specific use. Value-in-use is the value to one particular user, and may be above or below the market value of a property.

Investment value—is the value to one particular investor, and may or may not be higher than the market value of a property. Differences between the investment value of an asset and its market value provide the motivation for buyers or sellers to enter the marketplace. International Valuation Standards (IVS) define:

Investment value—the value of an asset to the owner or a prospective owner for individual investment or operational objectives.

Insurable value—is the value of real property covered by an insurance policy. Generally it does not include the site value.

Liquidation value—may be analyzed as either a forced liquidation or an orderly liquidation and is a commonly sought standard of value in bankruptcy proceedings. It assumes a seller who is compelled to sell after an exposure period which is less than the market-normal time-frame.

In the US, appraisals are for a certain type of value (e.g., foreclosure value, fair market value, distressed sale value, investment value). The most commonly used definition of value is Market Value. While Uniform Standards of Professional Appraisal Practice (USPAP) does not define Market Value, it provides general guidance for how Market Value should be defined:

a type of value, stated as an opinion, that presumes the transfer or sale of a property as of a certain date, under specific conditions set forth in the definition of the term identified by the appraiser as applicable in an appraisal.

Thus, the definition of value used in an appraisal or CMA (Current Market Analysis) analysis and report is a set of assumptions about the market in which the subject property may transact. It affects the choice of comparable data for use in the analysis. It can also affect the method used to value the property.

In some embodiments, the value of the paydown capital is a valuation of capital provided to a lender to reduce the balance owed on the real estate loan.

As used herein, facilitating a transaction is defined to mean activities including but not limited to providing information or instructions for the transaction.

As used herein, an allowed loan-to-value threshold is defined to mean a value including but not limited to a value of a loan-to-value ratio that is considered permissible for funding the loan.

As used herein, revenue capital deal terms is defined to mean terms of a transaction for a revenue capital repayment including but not limited to a repayment of capital from future revenue streams without creation of a debt associated with the capital, as described herein.

As used herein, paydown capital is defined to mean but is not limited to a transfer of capital to reduce a debt to in order to facilitate the creation of a refinancing loan.

In some embodiments, the method further includes performing a financial transaction for a debtor entity, wherein the debtor entity is a debtor under the refinance loan, calculating a division of funds based at least in part on the revenue-capital repayment terms and facilitating execution of the financial transaction based on the division of funds.

In some embodiments, the revenue capital repayment terms specify a transfer of a portion of the financial transaction to a provider of the paydown capital. A first portion of the transfer is applied to a royalty payment, and a second portion of the transfer is applied to a repayment of the capital provided to the lender to reduce the balance owed on the real estate loan. In some embodiments, the revenue capital repayment terms specify a transfer of a portion of the financial transaction to a provider of the paydown capital. A first portion of the transfer is applied to a royalty payment, and a second portion of the transfer is applied to a repayment of the capital provided to the lender to reduce the balance owed on the real estate loan. The relative sizes of the first portion of the transfer and the second portion of the transfer vary as a function of one or more attributes financial transaction.

In some embodiments, the method further includes performing a financial transaction for a debtor entity. The debtor entity is a debtor under the refinance loan. The financial transaction is a deposit of funds into an account of the debtor entity. In some embodiments, the method further includes calculating a division of based at least in part on the revenue-capital repayment terms. A first portion of the funds is calculated for a transfer to a provider of the paydown capital, and a second portion of the funds is calculated for a deposit in the account of the debtor entity. In some embodiments, the method further includes facilitating execution of the transfer and the deposit.

In some embodiments, the method further includes performing a financial transaction for a debtor entity. The debtor entity is a debtor under the refinance loan. The financial transaction is a withdrawal of funds from an account of the debtor entity. In some embodiments, the method further includes calculating a division of based at least in part on the revenue-capital repayment terms. A first portion of the funds is calculated for a transfer to a provider of the paydown capital. A second portion of the funds is calculated for transfer to an intended recipient of the withdrawal. In some embodiments, the method further includes facilitating execution of the transfer and the deposit.

Some embodiments may include a means for facilitating the refinancing of real estate loans. For example, a transaction management module may perform calculating a loan-to-value ratio, responsive to the loan-to-value ratio being greater than a allowed loan-to-value threshold in a refinancing of the real estate loan, calculating a value of paydown capital required to create a refinance loan-to-value ratio for a refinance loan that is less than or equal to the allowed loan-to-value threshold, and providing under revenue-capital repayment terms paydown capital equal to the value of paydown capital required to create the refinance loan-to-value ratio less than or equal to the allowed loan-to-value threshold, as described herein. The transaction management module may in some embodiments be implemented by a non-transitory, computer-readable storage medium and one or more processors (e.g., CPUs and/or GPUs) of a computing apparatus. The computer-readable storage medium may store program instructions executable by the one or more processors to perform calculating a loan-to-value ratio, responsive to the loan-to-value ratio being greater than a allowed loan-to-value threshold in a refinancing of the real estate loan, calculating a value of paydown capital required to create a refinance loan-to-value ratio for a refinance loan that is less than or equal to the allowed loan-to-value threshold, and providing under revenue-capital repayment terms paydown capital equal to the value of paydown capital required to create the refinance loan-to-value ratio less than or equal to the allowed loan-to-value threshold, as described herein. Other embodiments of the transaction management module may be at least partially implemented by hardware circuitry and/or firmware stored, for example, in a non-volatile memory.

### Example Implementations

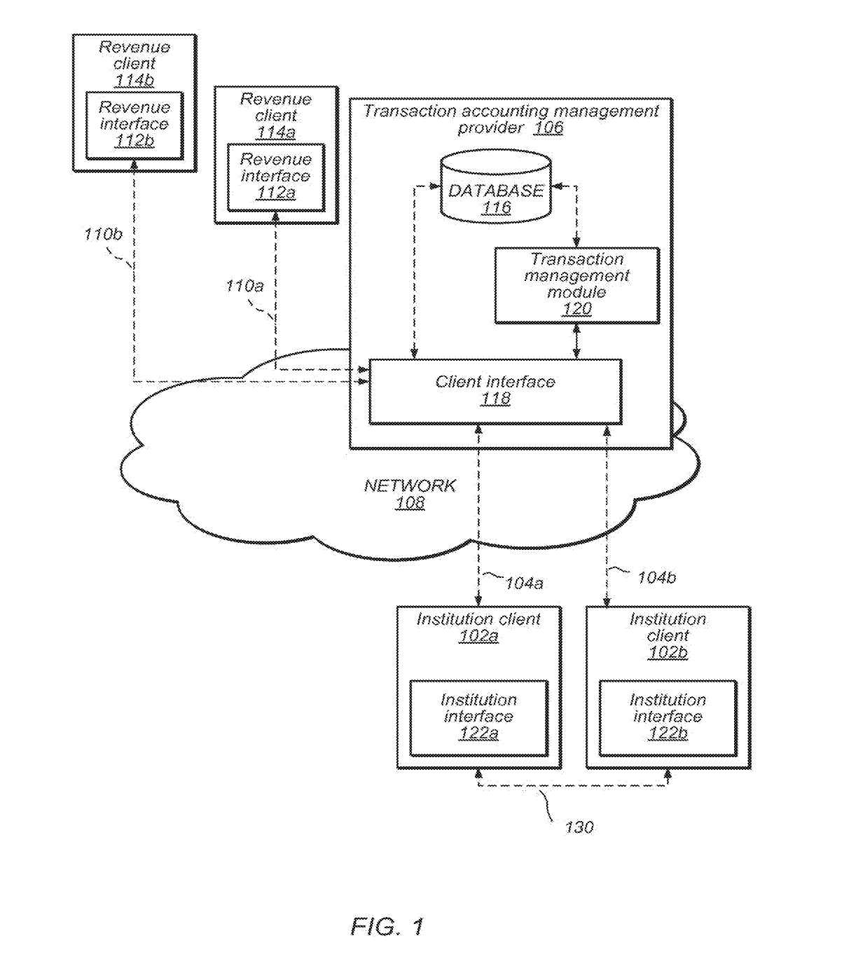

FIG. 1 illustrates a system architecture for tracking, managing and reporting payment obligations transactions, according to some embodiments. In some embodiments, a transaction accounting management provider 106 performs functions for tracking, managing and reporting transactions that include allocating funds based on payment obligations. In some embodiments, a transaction management module 120 executes instructions for tracking, managing and reporting transactions that include allocating funds based on payment obligations. In some embodiments, calculating the payment obligation includes allocating a payment portion to a return of capital, and allocating another payment portion to an agreed royalty payment.

Additionally, in some embodiments, a client interface is used for receiving payment determination data, such as over a network 108. In some embodiments, the payment determination data includes data 104a-104b received over a client interface 118 from institution clients 102a-102b, such as terms and conditions of revenue capital transactions, transaction details, transaction data for the transaction, transaction rules, historical data, balances owed, property value appraisals, and loan terms. In some embodiments, institution clients 102a-102b are systems for interacting with transaction accounting management provider 106 that are used by recipients of repayment of capital and of royalties under a revenue capital transaction. In some embodiments, institution clients 102a-102b are systems for interacting with transaction accounting management provider 106 that are used by other recipients, such as child support recipients or recipients of royalties in an intellectual property transaction.

In some embodiments, institution clients 102a-102b are systems for a financial services company involved in facilitating payments to recipients of repayment of capital and of royalties under a revenue capital transaction or to an operator of transaction accounting management provider 106. In some embodiments, the payment determination data includes data 110a-110b received over client interface 118 from revenue clients 114a-114b, such as documentation of revenue usable in a revenue capital transactions, appraisal values, or payment instructions.

In some embodiments, revenue clients 114a-114b are systems for interacting with revenue capital transaction accounting management provider 106 that are used by payers of repayment of capital and of royalties under a revenue capital transaction or other payment obligations, such as payment of child support, royalties, or other agreed obligations. In some embodiments, data 110a-110b containing payment instructions may be forwarded as data 104a-104b to institution clients 102a-102b to indicate an order for a financial transaction, thereby facilitating payment of an obligation. In some embodiments, data 110a-110b and data 104a-104b may include accounting reports of various aspects of the transactions for tracking, managing and reporting the transactions. In some embodiments, an amount of a current payment is based at least in part upon a value derived from the payment determination data. Various data 110a-110b and data 104a-104b may be stored in a database 116 for tracking, managing and reporting the revenue capital transactions.

For example, in one embodiment, an RC investor may use one of institution interfaces 122a-122b of institution clients 102a-102b to provide a business unit using revenue clients 114a-114b with $250K in exchange for 3% of the revenue of the business unit over a specified period of time, or until a specific payback amount is received. For example, a stream of payments totaling $750k may be required by the RC investor. In one example embodiment, $250k of the received revenue funds may be allocated to return to capital and $500k of the received revenue funds may be allocated to a royalty payment associated with a patent on the use of reporting software for tracking, managing and reporting the revenue capital transactions. In one embodiment, the business receiving the $250k will report its revenues at set periods (e.g., quarterly or monthly) using one or more revenue interfaces 112a-112b of revenue clients 114a-114b to report the revenues to transaction accounting management provider 106.

In some embodiments, revenue interfaces 112a-112b provide for manual data entry of data 110a-110b with respect to revenues. In some embodiments revenue interfaces 112a-112b provide for upload of documents containing data 110a-110b of revenues. In some embodiments, data 104a-104b of revenues may be received from institution clients 102a-102b, such as financial services providers that may communicate with each other and exchange payment data 130. In some embodiments, the amount of royalty may be calculated based in part on the remaining life of a patent.

Regardless of the specific deal or agreement or obligation terms, in some embodiments, encompass funding structures where future revenue is the primary means of repayment. In some embodiments, transactions described herein function without the use of balance-sheet debt or traditional equity. In some embodiments, payments are divided between return to capital and a patent royalty, as described below.

In some embodiments, transaction accounting management provider 106 may allocate funds based on payment obligations. In some embodiments, transaction management module 120 performs, using one or more processors, in response to a transaction on an account requested by one of revenue clients 114a-114b, comparing transaction data for the transaction to one or more transaction rules to determine if a payment obligation is applicable to the transaction, responsive to determining that the payment obligation is applicable to the transaction, calculating an allocation of funds based on the algorithmic representation of the agreement between the transaction recipient and the one or more parties of the agreement, and storing a record of the allocation of funds on a storage device for database 116. In some embodiments, the transaction rules provide an algorithmic representation of an agreement between a transaction recipient and one or more parties of the agreement stored in database 116.

In some embodiments, transaction management module 120 calculating the allocation of funds based on the algorithmic representation of the agreement between the transaction recipient and the one or more parties of the agreement further includes transaction management module 120 calculating a payment portion allocated to a return of capital, and another payment portion allocated to an agreed royalty payment. In some embodiments, transaction management module 120 calculating the allocation of funds based on the algorithmic representation of the agreement between the transaction recipient and the one or more parties of the agreement further includes transaction management module 120 calculating the allocation of funds based on the algorithmic representation of the agreement between the transaction recipient and the one or more parties of the agreement based at least in part on a date of the transaction.

In some embodiments, the transaction management module 120 calculating the allocation of funds based on the algorithmic representation of the agreement between the transaction recipient and the one or more parties of the agreement further includes calculating the allocation of funds based on the algorithmic representation of the agreement between the transaction recipient and the one or more parties of the agreement based at least in part on a percentage allocation of the transaction reflected in the algorithmic representation of the agreement between the transaction recipient and the one or more parties of the agreement stored in database 116.

In some embodiments, the transaction management module 120 calculating the allocation of funds based on the algorithmic representation of the agreement between the transaction recipient and the one or more parties of the agreement further includes calculating the allocation of funds based on the algorithmic representation of the agreement between the transaction recipient and the one or more parties of the agreement based at least in part on an amount of the transaction. In some embodiments, the transaction management module 120 comparing transaction data for the transaction to one or more transaction rules further comprises comparing transaction data for the transaction and historical data for the account to one or more transaction rules, all of which is stored in database 116. In some embodiments, transaction management module 120 facilitates a payment to the one or more parties of the agreement through institution clients 102a-102b. In some embodiments, transaction management module 120 generates a report based on the allocation of funds, which is provided to institution clients 102a-102b, and the report provides instructions for performing a payment.

Some embodiments transaction management module 120 may facilitate the refinancing of real estate loans. In some embodiments, transaction management module 120 calculate a loan-to-value ratio, responsive to the loan-to-value ratio being greater than a allowed loan-to-value threshold in a refinancing of the real estate loan, calculate a value of paydown capital required to create a refinance loan-to-value ratio for a refinance loan that is less than or equal to the allowed loan-to-value threshold, and provide under revenue-capital repayment terms paydown capital equal to the value of paydown capital required to create the refinance loan-to-value ratio less than or equal to the allowed loan-to-value threshold. In some embodiments, the loan-to-value ratio includes a function of a balance owed on a real estate loan, and a re-appraised property value of a property associated with the real estate loan.

In some embodiments, the value of the paydown capital is a valuation of capital provided to a lender to reduce the balance owed on the real estate loan. In some embodiments, transaction management module 120 performs a financial transaction for a debtor entity. The debtor entity is a debtor under the refinance loan. Transaction management module 120 calculates a division of funds based at least in part on the revenue-capital repayment terms and facilitating execution of the financial transaction based on the division of funds.

In some embodiments, the revenue capital repayment terms specify a transfer of a portion of the financial transaction to a provider of the paydown capital. A first portion of the transfer is applied to a royalty payment, and a second portion of the transfer is applied to a repayment of the capital provided to the lender to reduce the balance owed on the real estate loan. In some embodiments, the revenue capital repayment terms specify a transfer of a portion of the financial transaction to a provider of the paydown capital. A first portion of the transfer is applied to a royalty payment, and a second portion of the transfer is applied to a repayment of the capital provided to the lender to reduce the balance owed on the real estate loan. The relative sizes of the first portion of the transfer and the second portion of the transfer vary as a function of one or more attributes financial transaction.

In some embodiments, transaction management module 120 using institution clients 102a-102b performs a financial transaction for a debtor entity. The debtor entity is a debtor under the refinance loan. The financial transaction is a deposit of funds into an account of the debtor entity. In some embodiments, the method further includes calculating a division of based at least in part on the revenue-capital repayment terms. A first portion of the funds is calculated for a transfer to a provider of the paydown capital, and a second portion of the funds is calculated for a deposit in the account of the debtor entity. In some embodiments, transaction management module 120 using institution clients 102a-102b facilitates execution of the transfer and the deposit.

In some embodiments, transaction management module 120 using institution clients 102a-102b performs a financial transaction for a debtor entity. The debtor entity is a debtor under the refinance loan. The financial transaction is a withdrawal of funds from an account of the debtor entity. In some embodiments, the method further includes calculating a division of based at least in part on the revenue-capital repayment terms. A first portion of the funds is calculated for a transfer to a provider of the paydown capital. A second portion of the funds is calculated for transfer to an intended recipient of the withdrawal. In some embodiments, the method further includes facilitating execution of the transfer and the deposit.

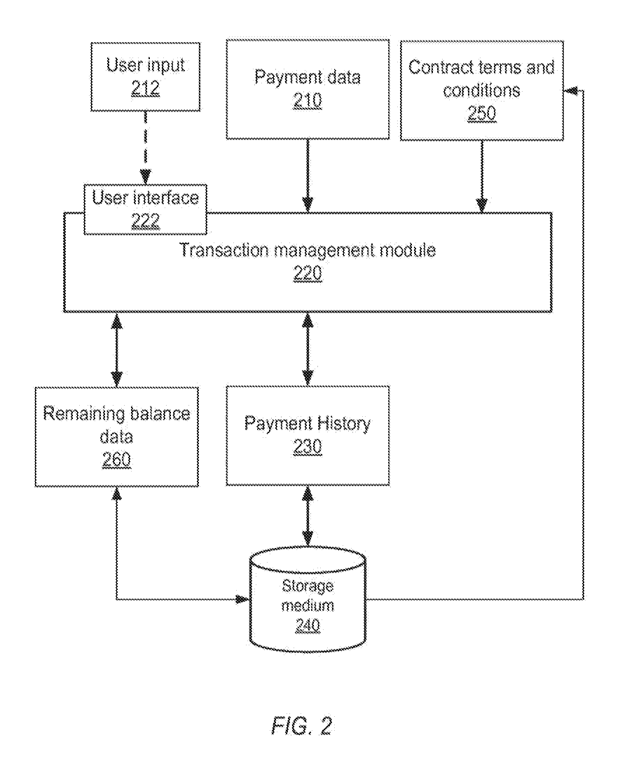

FIG. 2 depicts a module that that may be used for implementing tracking, managing and reporting of transactions, according to some embodiments. A transaction management module 220 includes instructions for, in some embodiments, calculating a payment obligation. In some embodiments, the instructions for calculating the payment obligation include instructions for allocating a payment portion to a return of capital, and allocating another payment portion to an agreed royalty payment. Some embodiments further include instructions for receiving payment determination data. In some embodiments, the instructions for calculating the payment obligation further comprise instructions for determining an amount of a current payment based at least in part upon a value derived from the payment determination data.

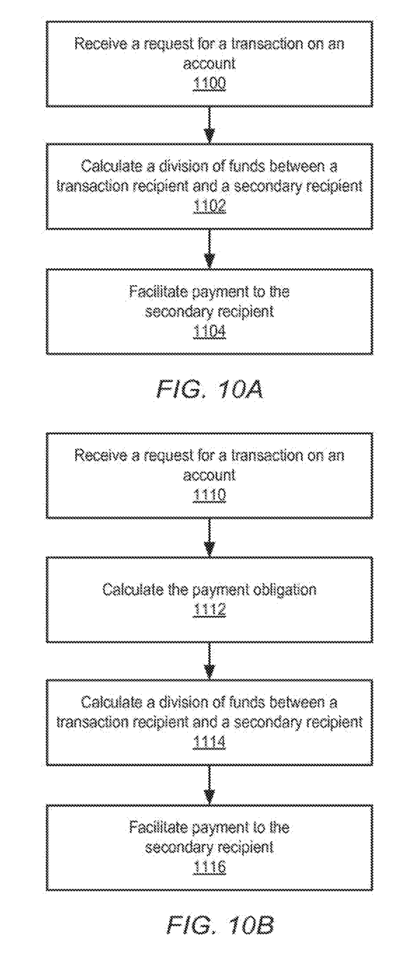

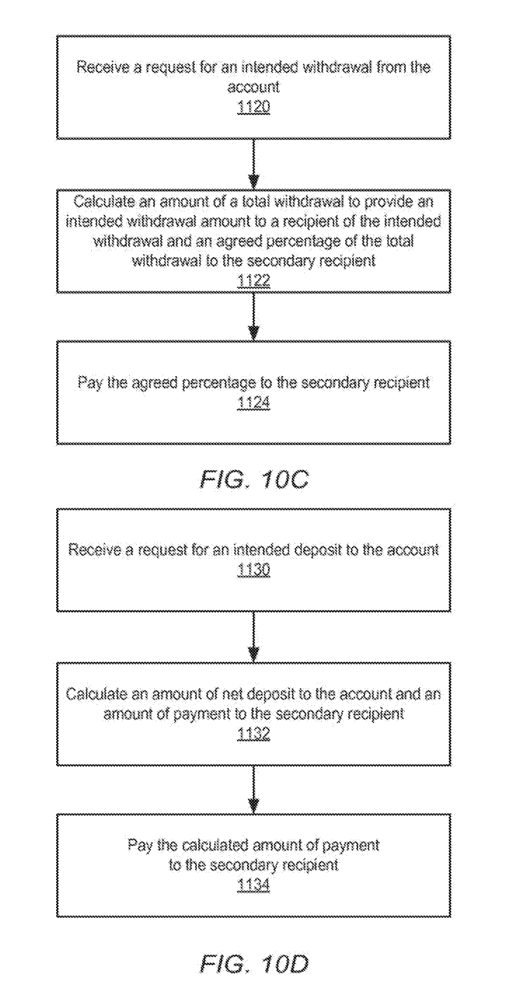

Transaction management module 120 may, for example, implement one or more of a tool for calculating payment obligations based on reported revenue and input data related to terms and conditions, a tool for calculating revenue from input data, a tool for tracking and reporting obligations and payments a tool for facilitating payments through electronic transactions with financial services providers. FIG. 10 illustrates an example computer system on which embodiments of module 220 may be implemented.

Transaction management module 220 receives as input one or more items of payment data 210. Payment data 210 varies between embodiments. Examples include but are not limited to up/downloaded receipt and bank statement papers, up/downloaded financial statements from a financial services provider, imported banking and transaction data directly from one or more remote bank accounts or financial institutions that provide banking services to the licensee, and manually entered revenue information. Embodiments support data intake ranging from manual entry to automatic integrated accounting support from financial institutions. In some embodiments, reporting is integrated with an accounting provider or accounting package and can be provided on an automated searching basis.

Transaction management module 220 receives as input contract terms and conditions 250 describing the required payment obligations for a revenue capital transaction. In some embodiments, transaction management module 220 may receive user input 212 indicating revenue, providing payment instructions, indicating terms and conditions of a revenue capital transaction, or requesting tracking reports for payments received and obligations remaining Transaction management module 220 receives payment history information 230 and remaining balance data 260. Transaction management module 220 then calculates a payment obligation, which may include allocating a payment portion to a return of capital, and allocating another payment portion to an agreed royalty payment. Transaction management module 220 may receive information indicating payments received. Transaction management module 220 then updates payment history information 230 and remaining balance data 260 and may provide payment history information 230 and remaining balance data 260 in reports reflecting the tracking, management and reporting of revenue capital transactions. Payment history information 230 and remaining balance data 260 may, for example, be stored to a storage medium 240, such as system memory, a disk drive, DVD, CD, etc.

In some embodiments, transaction management module 220 may provide a user interface 222 via which a user may interact with the transaction management module 220, for example to set up terms and conditions of a revenue capital transaction, report revenue, arrange payments, and request reports. In some embodiments, the user interface may provide user interface elements whereby the user may select options including, but not limited to, patent term for royalty and depreciation calculations, payment terms, and orders for financial transactions.

In some embodiments, transaction management module 220 may allocate funds based on payment obligations contained in contract terms and conditions 250. In some embodiments, in response to a transaction on an account, which may be detected either through payment data 210 or through user input 212, transaction management module 220 compares the transaction data for the transaction (payment data 210 or user input 212) to one or more transaction rules in contract terms and conditions 250 to determine if a payment obligation is applicable to the transaction. Responsive to determining that the payment obligation is applicable to the transaction, transaction management module 220 calculates an allocation of funds based on the algorithmic representation of the agreement between the transaction recipient and the one or more parties of the agreement, represented in contract terms and conditions 250. Transaction management module 220 stories a record of the allocation of funds on a storage device, such as payment history 230 on storage medium 240. In some embodiments, the transaction rules in contract terms and conditions 250 provide an algorithmic representation of an agreement between a transaction recipient and one or more parties of the agreement.

In some embodiments, transaction management module 220 calculating the allocation of funds based on the algorithmic representation of the agreement in contract terms and conditions 250 between the transaction recipient and the one or more parties of the agreement further includes transaction management module 220 calculating a payment portion allocated to a return of capital, and another payment portion allocated to an agreed royalty payment. In some embodiments, transaction management module 220 calculating the allocation of funds based on the algorithmic representation of the agreement between the transaction recipient and the one or more parties of the agreement further includes transaction management module 220 calculating the allocation of funds based on the algorithmic representation of the agreement in contract terms and conditions 250 between the transaction recipient and the one or more parties of the agreement based at least in part on a date of the transaction.

In some embodiments, transaction management module 220 calculating the allocation of funds based on the algorithmic representation of the agreement in contract terms and conditions 250 between the transaction recipient and the one or more parties of the agreement further includes transaction management module 220 calculating the allocation of funds based on the algorithmic representation of the agreement between the transaction recipient and the one or more parties of the agreement based at least in part on a percentage allocation of the transaction reflected in the algorithmic representation of the agreement between the transaction recipient and the one or more parties of the agreement.

In some embodiments, transaction management module 220 calculating the allocation of funds based on the algorithmic representation of the agreement between the transaction recipient and the one or more parties of the agreement in contract terms and conditions 250 further includes calculating the allocation of funds based on the algorithmic representation of the agreement between the transaction recipient and the one or more parties of the agreement based at least in part on an amount of the transaction. In some embodiments, transaction management module 220 compares transaction data for the transaction to one or more transaction rules further includes transaction management module 220 comparing transaction data for the transaction and historical data from payment history 230 for the account to one or more transaction rules. In some embodiments, transaction management module 220 facilitates a payment to the one or more parties of the agreement. In some embodiments, transaction management module 220 generates a report based (e.g., payment history 230 and remaining balance data 260) on the allocation of funds, wherein the report provides instructions for performing a payment.

In some embodiments, transaction management module 220 calculates a loan-to-value ratio. Responsive to the loan-to-value ratio being greater than a allowed loan-to-value threshold in a refinancing of the real estate loan, transaction management module 220 calculates a value of paydown capital required to create a refinance loan-to-value ratio for a refinance loan that is less than or equal to the allowed loan-to-value threshold, and provides under revenue-capital repayment terms paydown capital equal to the value of paydown capital required to create the refinance loan-to-value ratio less than or equal to the allowed loan-to-value threshold. In some embodiments, the loan-to-value ratio includes a function of a balance owed on a real estate loan, and a re-appraised property value of a property associated with the real estate loan.

In some embodiments, the value of the paydown capital is a valuation of capital provided to a lender to reduce the balance owed on the real estate loan. In some embodiments, transaction management module 220 performs a financial transaction for a debtor entity. The debtor entity is a debtor under the refinance loan. In some embodiments, transaction management module 220 calculates a division of funds based at least in part on the revenue-capital repayment terms and facilitates execution of the financial transaction based on the division of funds.

In some embodiments, the revenue capital repayment terms specify a transfer of a portion of the financial transaction to a provider of the paydown capital. A first portion of the transfer is applied to a royalty payment, and a second portion of the transfer is applied to a repayment of the capital provided to the lender to reduce the balance owed on the real estate loan. In some embodiments, the revenue capital repayment terms specify a transfer of a portion of the financial transaction to a provider of the paydown capital. A first portion of the transfer is applied to a royalty payment, and a second portion of the transfer is applied to a repayment of the capital provided to the lender to reduce the balance owed on the real estate loan. The relative sizes of the first portion of the transfer and the second portion of the transfer vary as a function of one or more attributes financial transaction.

In some embodiments, the method further includes performing a financial transaction for a debtor entity. The debtor entity is a debtor under the refinance loan. The financial transaction is a deposit of funds into an account of the debtor entity. In some embodiments, transaction management module 220 calculates a division of based at least in part on the revenue-capital repayment terms. A first portion of the funds is calculated for a transfer to a provider of the paydown capital, and a second portion of the funds is calculated for a deposit in the account of the debtor entity. In some embodiments, transaction management module 220 facilitates execution of the transfer and the deposit.

In some embodiments, transaction management module 220 performs a financial transaction for a debtor entity. The debtor entity is a debtor under the refinance loan. The financial transaction is a withdrawal of funds from an account of the debtor entity. In some embodiments, transaction management module 220 calculates a division of based at least in part on the revenue-capital repayment terms. A first portion of the funds is calculated for a transfer to a provider of the paydown capital. A second portion of the funds is calculated for transfer to an intended recipient of the withdrawal. In some embodiments, transaction management module 220 facilitates execution of the transfer and the deposit.

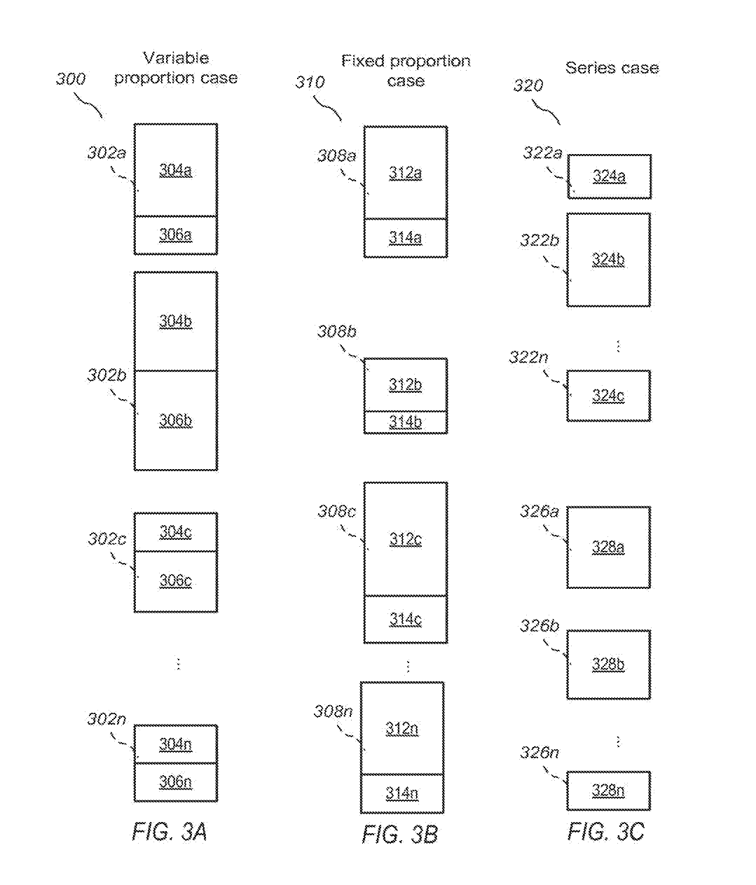

FIGS. 3A-3C illustrate a series of payments that may be tracked, managed and reported in revenue capital transactions, according to some embodiments. Turning to FIG. 3A, a series of payments 300 illustrating a variable proportion revenue capital transaction includes payments 302a-302n is depicted. In the embodiment described herein, the values of payments 302a-302n vary in proportion to the revenue of a payee (in addition to other factors). Payments 302a-302n each contain first portions 304a-304n allocated to a return to capital and second portions 306a-306n allocated to a patent royalty. The proportion between first portions 304a-304n allocated to a return to capital and second portions 306a-306n allocated to a patent royalty vary between payments 302a-302n based on factors defined by a set of terms and conditions reported to a revenue capital transaction management provider. In such a series of payments a revenue capital transaction management provider uses a transaction management module to calculate both the sizes payments 302a-302n and the proportion between first portions 304a-304n allocated to a return to capital and second portions 306a-306n allocated to a patent royalty vary between payments 302a-302n based on factors defined by a set of terms and conditions reported to a revenue capital transaction management provider.

Turning to FIG. 3B, a series of payments 310 illustrating a fixed proportion revenue capital transaction includes payments 308a-308n is illustrated. In the embodiment described herein, the values of payments 308a-308n vary in proportion to the revenue of a payee (in addition to other factors). Payments 308a-308n each contain first portions 312a-312n allocated to a return to capital and second portions 314a-314n allocated to a patent royalty. The proportion between first portions 312a-312n allocated to a return to capital and second portions 314a-314n allocated to a patent royalty are fixed between payments 308a-308n based on terms and conditions reported to a revenue capital transaction management provider, even though the size of payments 308a-308n varies in proportion to the revenue of a payee (in addition to other factors). In such a series of payments a revenue capital transaction management provider uses a transaction management module to calculate both the sizes payments 310a-310n based on factors defined by a set of terms and conditions reported to a revenue capital transaction management provider, and the proportion between first portions 312a-312n allocated to a return to capital and second portions 312a-312n allocated to a patent royalty remains fixed. In such a series of payments a revenue capital transaction management provider uses a transaction management module to calculate the sizes payments 308a-308n, while the proportion between first portions 312a-312n allocated to a return to capital and second portions 314a-314n allocated to a patent royalty vary between payments 308a-308n remains fixed based on a set of terms and conditions reported to a revenue capital transaction management provider.

Turning to FIG. 3C, a series of payments 320 illustrating a series of revenue capital transaction includes payments 322a-322n and payments 326a-326n, in which each of payments 322a-322n and payments 326a-326n is entirely either return to capital or royalty, is depicted. In the embodiment described herein, the values of payments 322a-322n and payments 326a-326n vary in proportion to the revenue of a payee (in addition to other factors). Payments 322a-322n each contain first portions 324a-324n allocated to a return to capital and payments 326a-326n contain second portions 328a-328n allocated to a patent royalty. In such a series of payments 322a-322n and payments 326a-326n a revenue capital transaction management provider uses a transaction management module to calculate both the sizes payments 322a-322n and payments 326a-326n and which of payments 322a-322n and payments 326a-326n are return to capital or royalty based on factors defined by a set of terms and conditions reported to a revenue capital transaction management provider. In such a series of payments a revenue capital transaction management provider uses a transaction management module to calculate the sizes of the sizes payments 322a-322n and payments 326a-326n and which of payments 322a-322n and payments 326a-326n are return to capital or royalty based on a set of terms and conditions reported to a revenue capital transaction management provider. In addition to the three payment series examples illustrated herein, embodiments that are hybrids of the these transaction series types are supported by embodiments and fall within the scope and intent of the present disclosure

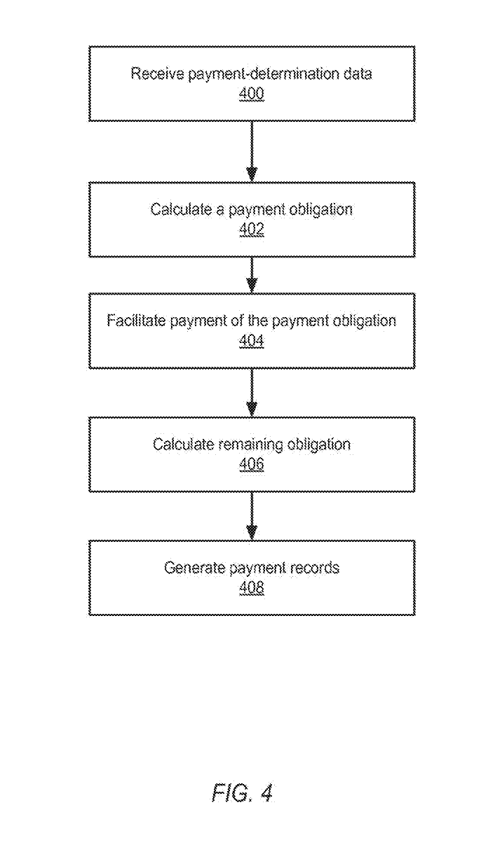

FIG. 4 is a high-level logical flowchart of operations usable for tracking, managing and reporting revenue capital transactions, according to some embodiments. Payment determination data is received (block 400). A payment obligation is calculated (block 402). Payment of the payment obligation is facilitated (block 404). A remaining obligation is calculated (block 406). Payment records are generated (block 408) for accounting and tax purposes.

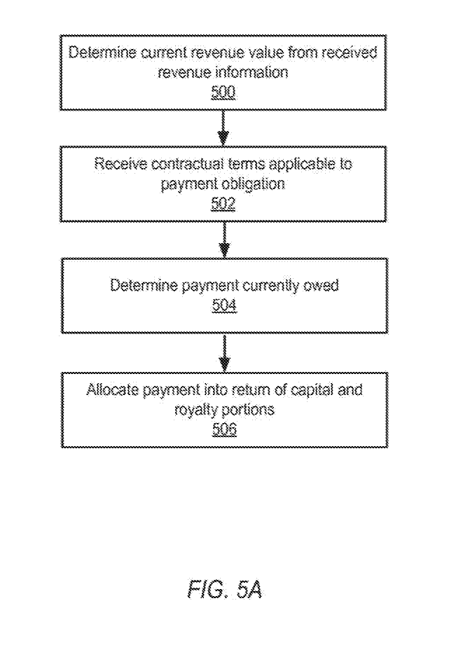

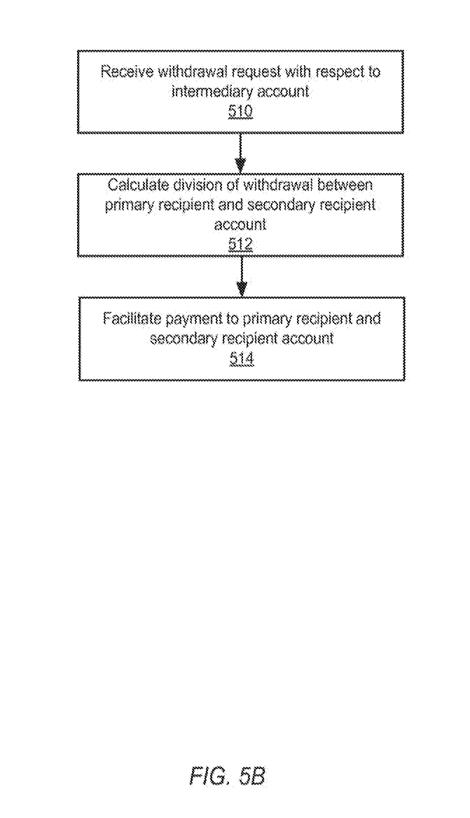

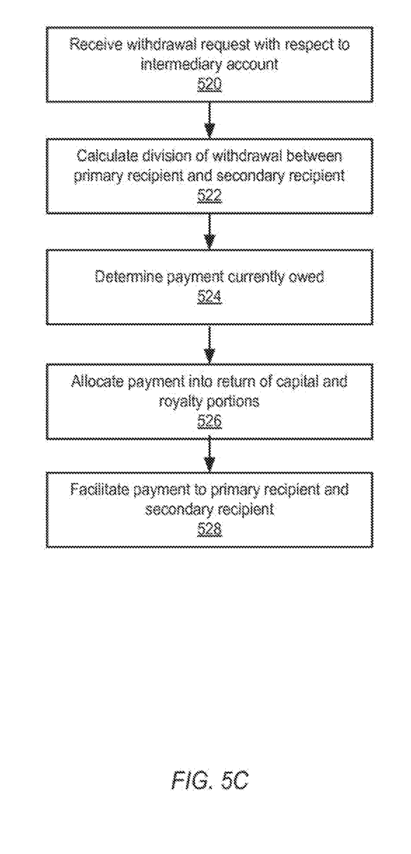

FIG. 5A is a high-level logical flowchart of operations that can be used for calculating a payment obligation in the context of for tracking, managing and reporting revenue capital transactions, according to some embodiments. A current revenue value is determined from received revenue information (block 500). Contractual terms applicable to a payment obligation are received (block 502). A payment currently owed is determined (block 504). The payment is allocated to return of capital and royalty portions (block 506).

FIG. 5B is a high-level logical flowchart of operations that can be used for calculating a payment obligation in the context of tracking, managing and reporting revenue capital transactions, according to some embodiments. A withdrawal request is received with respect to intermediary account (block 510). A division of withdrawal between primary recipient and secondary recipient account is calculated (block 512). Payment to a primary recipient and a secondary recipient account is facilitated (block 514).

FIG. 5C is a high-level logical flowchart of operations that can be used for calculating a payment obligation in the context of tracking, managing and reporting revenue capital transactions, according to some embodiments. A withdrawal request is received with respect to intermediary account (block 520). Division of a withdrawal between a primary recipient and a secondary recipient is calculated (block 522). A payment currently owed is determined (block 524). The payment is allocated into return to capital and royalty portions (block 526). Payment to primary and secondary recipients is facilitated (block 528).

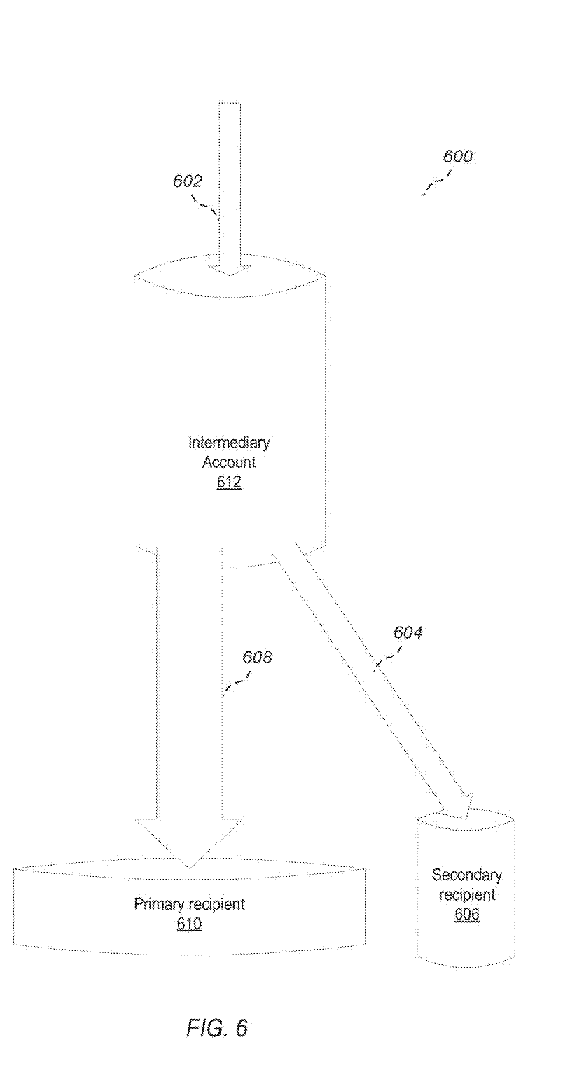

FIG. 6 depicts a flow-of-funds diagram illustrating an account used in some embodiments. A transaction management system 600 may include an account, such as intermediate account 612 into which deposits 602 flow. Funds leave the account by being routed through withdrawals 608 to a primary recipient 610 and repayments 604 to a secondary recipient 606. In response to a transaction on an account, such as a deposit 602 on intermediate account 612 a comparison is made for comparing transaction data for the transaction (deposit 602) to one or more transaction rules to determine if a payment obligation is applicable to the transaction. The transaction rules provide an algorithmic representation of an agreement between a transaction recipient and one or more parties of the agreement, such as secondary recipient 606. Responsive to determining that the payment obligation is applicable to the transaction, an allocation of funds based on the algorithmic representation of the agreement is calculated between the transaction recipient (intermediate account 612) and the one or more parties of the agreement (secondary recipient 606). A record of the allocation of funds is stored on a storage device. In some embodiments, calculating the allocation of funds based on the algorithmic representation of the agreement between the transaction recipient and the one or more parties of the agreement further comprises calculating a payment portion allocated to a return of capital, and another payment portion allocated to an agreed royalty payment.

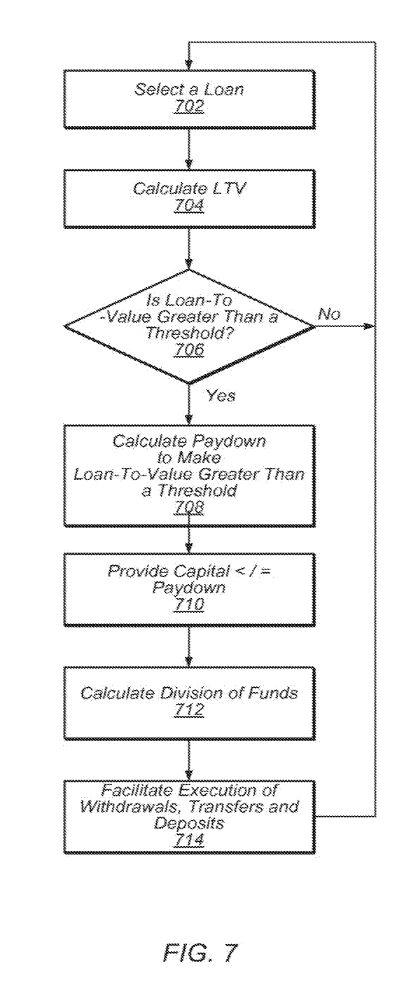

FIG. 7 illustrates a high-level logical flowchart of operations that can be used in conjunction with an account in some embodiments. In some embodiments, a transaction management module, such as transaction management module 220 described above with regard to FIG. 1, or other module or component implementing the operations illustrated in FIG. 7, may select a loan for analysis (block 702). In some embodiments, the loan is associated with real estate and refinancing of real estate loans.

Once a loan is selected for analysis (block 702), a loan to value ratio may be calculated (block 704). In some embodiments the loan-to-value ratio is calculated by transaction management module 220. In some embodiments the loan-to-value ratio comprises a function of a balance owed on a real estate loan and a re-appraised property value of a property associated with the real estate loan. In various embodiments, the loan-to-value ratio is compared to a threshold value to determine whether a paydown of capital is required (block 706). In some embodiments, it is desirable for the refinance loan-to-value ratio for a refinance loan to be less than or equal to the allowed loan-to-value threshold. For example, if the loan-to-value ratio is not greater than an allowed loan-to-value threshold, the method returns to selection of a loan (block 702). Otherwise, if the loan-to-value ratio is greater than an allowed loan-to-value threshold, a value of paydown capital required to create a refinance loan-to-value ratio for a refinance loan is calculated (block 708, yes).

If the loan-to-value ratio is greater than the threshold, and the value of a paydown has been calculated, paydown capital may be provided (block 710) to create a refinance loan-to-value ratio less than or equal to the allowed loan-to-value threshold. For example, transaction management module 220 may provide, under revenue-capital repayment terms, paydown capital equal to the value of paydown capital required (block 710) to create the refinance loan-to-value ratio less than or equal to the allowed loan-to-value threshold. In some embodiments, the value of the paydown capital is a valuation of capital provided to a lender to reduce the balance owed on the real estate loan.

In some embodiments, transactions are performed for the debtor. A variety of different implementations are contemplated. For example, a financial transaction may be performed for a debtor entity that is the debtor under the refinance loan. In various embodiments the transaction may be a deposit while in some embodiments the transaction may be a withdrawal. In an example of a deposit, the financial transaction is a deposit of funds into an account(s) of the debtor entity. The transaction may include calculating a division of funds based at least in part on the revenue-capital repayment terms (block 712). For example, a first portion of the funds may be calculated for a transfer to a provider of the paydown capital, and a second portion of the funds may be calculated for a deposit in the account of the debtor entity. In an example of a withdrawal, the financial transaction is a withdrawal of funds from an account of the debtor entity. The transaction may include calculating a division of funds based at least in part on the revenue-capital repayment terms. For example, a first portion of the funds may be calculated for a transfer to a provider of the paydown capital, and a second portion of the funds may be calculated for transfer to an intended recipient of the withdrawal. Once the calculations have been performed, some embodiments facilitate execution of the withdrawal(s), transfer(s) and the deposit(s) (block 714).

Various embodiments include a division of the funds of the financial transaction. For example, a division of funds may be calculated based at least in part on the revenue-capital repayment terms. In some embodiments, the revenue capital repayment terms specify a transfer of a portion of the financial transaction to a provider of the paydown capital. A first portion of the transfer may be applied to the royalty payment, and a second portion of the transfer may be applied to a repayment of the capital provided to the lender to reduce the balance owed on the real estate loan. In another embodiment, once again, the revenue capital repayment terms specify a transfer of a portion of the financial transaction to a provider of the paydown capital and a first portion of the transfer is applied to a royalty payment. However, in this embodiment, a second portion of the transfer is applied to a repayment of the capital provided to the lender to reduce the balance owed on the real estate loan. In this embodiment, the relative sizes of the first portion of the transfer and the second portion of the transfer may vary as a function of one or more attributes financial transaction.

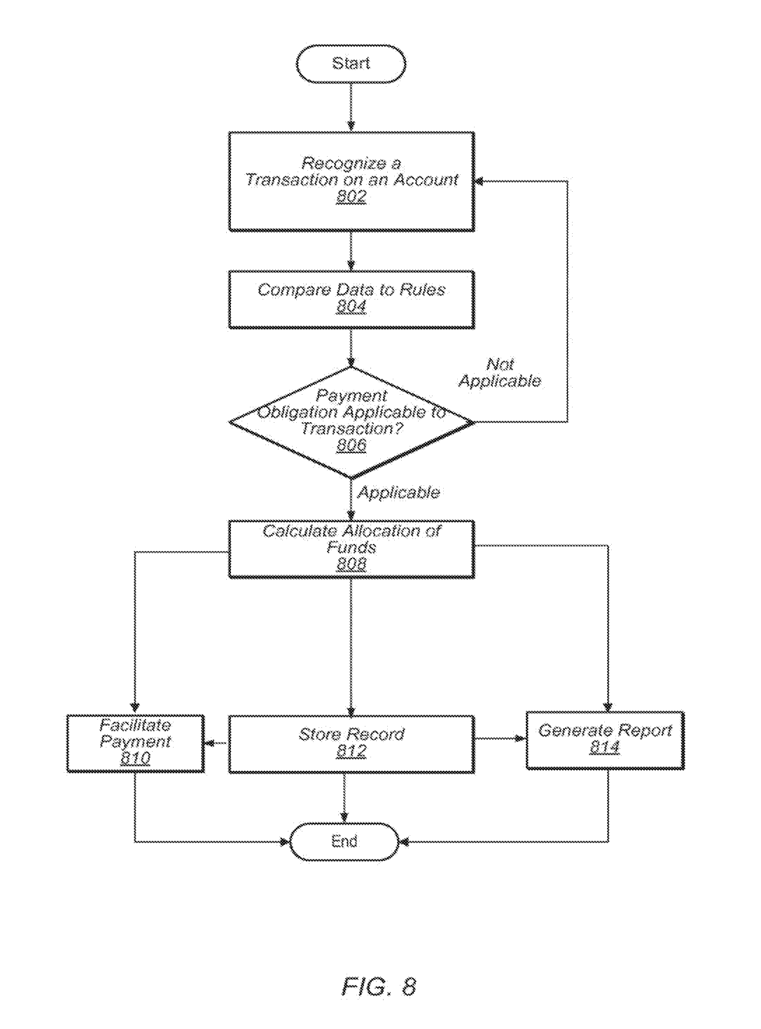

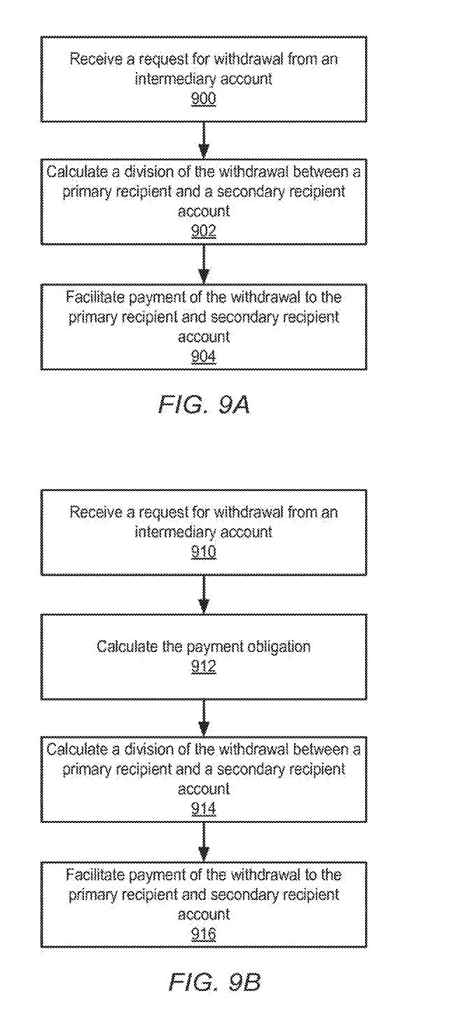

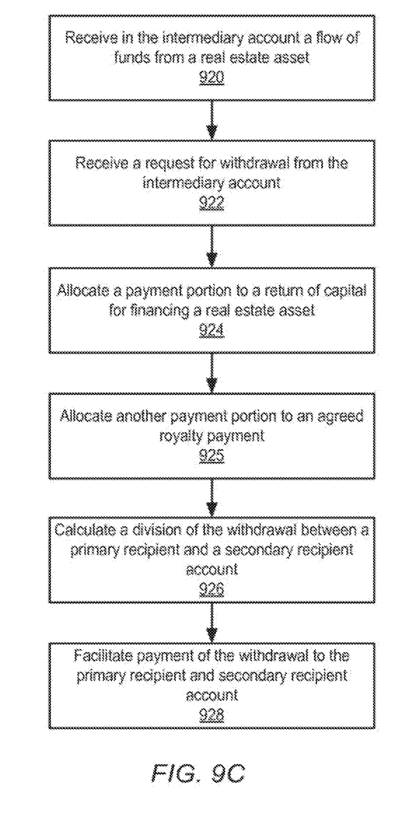

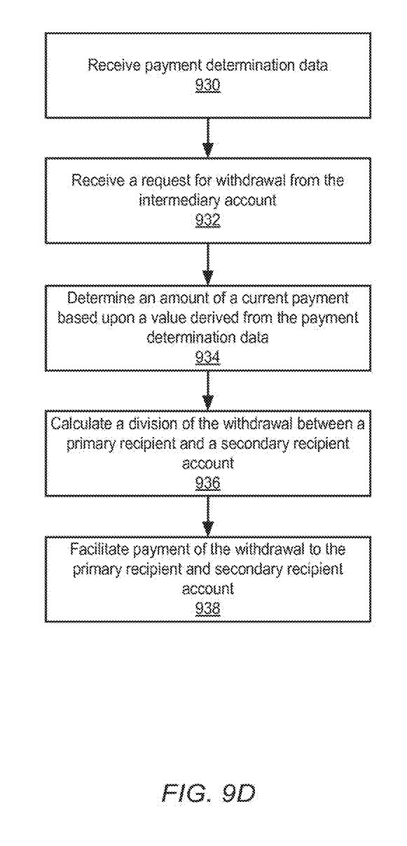

FIG. 8 illustrates a high-level logical flowchart of operations that can be used in conjunction with an account in some embodiments. In some embodiments, a transaction management module, such as transaction management module 220 described above with regard to FIG. 1, or other module or component implementing the operations illustrated in FIG. 9A, may recognize a transaction on an account (block 802). In response to the transaction, data is compared to rules (block 804) and a determination is made whether a payment obligation is applicable to the transaction (block 806). For example, in one embodiment, transaction management module 220 may compare (block 804) transaction data for the transaction to one or more transaction rules to determine if a payment obligation is applicable to the transaction (block 806). In some embodiments, comparing transaction data for the transaction to one or more transaction rules includes comparing transaction data for the transaction and historical data for the account to one or more transaction rules. In various embodiments, the transaction rules provide an algorithmic representation of an agreement between a transaction recipient and one or more parties of the agreement. If it is determined that the payment obligation is not applicable to the transaction (block 806, Not Applicable) the method returns to recognizing transactions on accounts (block 802). However, if transaction management module 220 determines that the payment obligation is applicable (block 806, Applicable) an allocation of funds is calculated (block 808).

In various embodiments, in response to the determination that the payment obligation is applicable to the transaction (block 806, Applicable) the allocation of funds is calculated based on the algorithmic representation of the agreement between the transaction recipient and the one or more parties of the agreement. Various methods of calculating the allocation of funds based on the algorithmic representation of the agreement between the transaction recipient and the one or more parties of the agreement (the “calculating”) are contemplated herein. In some embodiments the calculation is performed by transaction module 220. In some embodiments, the calculating includes calculating a payment portion allocated to a return of capital, and another payment portion allocated to an agreed royalty payment. In some embodiments, the calculating includes calculating the allocation of funds based on the algorithmic representation of the agreement between the transaction recipient and one or more parties of the agreement (“the “algorithmic calculation”). In some embodiments, the algorithmic calculation includes calculating the allocation of funds based on the algorithmic representation of the agreement between the transaction recipient and the one or more parties of the agreement are based at least in part on a date of the transaction. Other embodiments are contemplated. For example, in some embodiments the algorithmic calculation is based at least in part on a percentage allocation of the transaction reflected in the algorithmic representation of the agreement between the transaction recipient and the one or more parties of the agreement. In some embodiments the algorithmic calculation is based at least in part upon an amount of the transaction. Once the funds have been calculated, payments may be facilitated (block 810), records stored (block 812) and reports generated (block 814). Embodiments will vary as to which (one or more of) blocks 810, 812, and 814 are executed. In some embodiments, transaction module 220 facilitates payment to the one or more parties of the agreement. Furthermore, transaction management module 220 may store a record of the allocation of the funds on a storage device, such as storage medium 240 for example. Reports based on the allocation of funds may be generated, wherein the report provides instructions for performing a payment. For example, transaction module 220 may generate a report from the stored records.

FIG. 9A illustrates a high-level logical flowchart of operations that can be used in conjunction with an account in some embodiments. In some embodiments, a transaction management module, such as transaction management module 220 described above with regard to FIG. 1, or other module or component implementing the operations illustrated in FIG. 9A, may receive a request for withdrawal (block 900) from an intermediary account, such as intermediary account 612 described above with regard to FIG. 6A. In response to receiving this request, the transaction management module may calculate a division of the withdrawal (block 902) between a primary recipient account, such as primary recipient 610 described above with regard to FIG. 6A, and a secondary recipient account, such as secondary recipient 606 described above with regard to FIG. 6B. This calculation may be based, at least in part, on a payment obligation attached to the intermediary account. In some embodiments, transaction management module may also calculate the payment obligation, such as illustrated in FIG. 9B. However, in at least some embodiments, the transaction management module may implement the operations depicted in FIG. 9A.

A variety of different implementations of calculating the division of the withdrawal (block 902) may be employed. The primary recipient account and the secondary recipient account may be operated by different entities. For example, in some embodiments, the division of the withdrawal may be between a real estate management entity recipient account and a financing entity recipient account. Additionally, the payment obligation attached to the intermediary account may be related to a particular asset. Continuing with the above example embodiment, in calculating a division of the withdrawal between a real estate management recipient account and a financing entity recipient account may, a transaction management module may calculate the division based, at least in part, on a payment obligation attached to the intermediary account as a condition of a refinance of debt obligations related to a real estate asset. As numerous other entities may operate the primary and secondary recipient accounts and numerous different assets may be related to an intermediary account, the above examples are not intended to be limiting.

In some embodiments, the division of the withdrawal may be between primary and secondary recipient accounts for a particular purpose. For example, in some embodiments, a transaction management module may calculate a division of the withdrawal between a recipient account for primary short-term spending and a recipient account for long-term spending. Additionally, in some embodiments, this calculation may be based, at least in part, for a payment obligation in a particular agreement, such as a payment obligation in a savings agreement. Similarly, in some embodiments, a transaction management module may calculate a division of the withdrawal between a recipient account for primary short-term spending and a recipient account for charitable donation. In such an embodiment, the calculation may be based, at least in part, on a charitable donation agreement. As numerous other recipient account purposes and payment obligations in agreements may be envisioned by one of ordinary skill in the art, the examples given above are not intended to be limiting.

A transaction management module may, in some embodiments, facilitate payment of the withdrawal (block 904) to the primary recipient account and the secondary recipient account, such as through the various communication methods and processes described above with regard to FIG. 1. Note, that the above flowchart is given for illustrative purposes only, and as such may not be construed as to be limiting as to a particular ordering of the blocks shown.

FIG. 9B illustrates a high-level logical flowchart of operations that can be used in conjunction with an account in some embodiments. Similar to FIG. 9A discussed above, in some embodiments, a transaction management module, such as transaction management module 220 described above with regard to FIG. 1, or other module or component implementing the operations illustrated in FIG. 9B, may receive a request for withdrawal (block 910) from an intermediary account, such as intermediary account 612 described above with regard to FIG. 6A. A transaction management module may then calculate the payment obligation (block 912).

A variety of different implementations of calculating the payment obligation (block 912) may be employed. In some embodiments, a transaction management module may allocate a payment portion to a return of capital and allocate another payment portion to an agreed royalty payment (block 914). The payment portions allocated to a return of capital and agreed royalty payment may be related to a particular asset.

FIG. 9C illustrates one such example. FIG. 9C illustrates a high-level logical flowchart of operations that can be used in conjunction with an account in some embodiments. Some embodiments may receive in the intermediary account a flow of funds from a real estate asset (block 920). A transaction management module may receive a request for withdrawal from the intermediary account (block 922). To calculate the payment obligation (block 912), a transaction management module may allocate a payment portion to a return of capital for financing a real estate asset (block 924) and allocate a payment portion to an agreed royalty payment (block 925). Based, at least in part, on the payment obligation, a transaction management module may calculate a division between a primary recipient and a secondary recipient account (block 926). A transaction may then facilitate payment of the withdrawal to the primary recipient account and the secondary recipient account (block 928). Similar to FIG. 9C, in another example embodiment, a flow of rental funds from a commercial real estate asset may be received. When calculating the payment obligation a transaction management module may allocate a payment portion to a return of capital for bridge financing for a refinance of debt obligations related to the real estate asset and allocate another payment portion to an agreed royalty payment. In light of the wide variety of assets that may be relate to the payment portions allocated to a return of capital and agreed royalty payment, the examples and illustrations given above are not intended to be limiting. In some other embodiments, to calculate the payment obligation (block 912), a transaction management module may utilize payment determination data.

FIG. 9D illustrates a high-level logical flowchart of operations that can be used in conjunction with an account and payment determination data, in some embodiments. The transaction management module may receive payment determination data (block 930). The transaction management module may also receive a request for withdrawal from the intermediary account (block 932). To calculate the payment obligation (block 912), the transaction management module may determine an amount of a current payment based, at least in part, upon a value derived from the payment determination data (block 934). The transaction management module may then calculate a division of the withdrawal between a primary recipient and secondary recipient account (block 936) based on the calculated payment obligation, such as according to one of the various methods described above with regard to FIG. 9A. The transaction management module may then facilitate payment of the withdrawal (block 938) to the primary recipient account and the secondary recipient account.

Referring back to FIG. 9B, a transaction management module may then calculate a division of the withdrawal between a primary recipient account and a secondary recipient account (block 914) based, at least in part, on the calculated payment obligation (block 912). Various embodiments may implement the various different implementations of calculating the division discussed above with regard to block 902. A transaction management module may then facilitate payment of the withdrawal to the primary recipient account and secondary recipient account. Note, that the above flowcharts are given for illustrative purposes only, and as such may not be construed as to be limiting as to a particular ordering of operations according to the blocks as depicted.

FIG. 10A illustrates a high-level logical flowchart of operations that can be used in conjunction with an account in some embodiments. In some embodiments, a transaction management module, such as transaction management module 220 described above with regard to FIG. 1, or other module or component implementing the operations illustrated in FIG. 10A, may receive a request for a transaction on an account (block 1100). In response to receiving the request, the transaction management module may calculate a division of funds between a transaction recipient and a secondary recipient (block 1102), such as secondary recipient 606 described above with regard to FIG. 6A. This calculation may be based, at least in part, on a payment obligation attached to the account. In some embodiments, the transaction management module may also calculate the payment obligation, such as illustrated in FIG. 10B. However, in at least some embodiments, the transaction management module may implement the operations depicted in FIG. 10A.

In some embodiments, a variety of different types of requests may be received by the transaction management module. For example, a withdrawal request or a deposit request may be received by the transaction management module. In response, various embodiments of a transaction management module may implement different methods for calculating the division of funds between the transaction recipient and the secondary recipient (block 1102) and facilitating payment to the secondary recipient (block 1116). FIG. 10C, illustrates a high-level logical flowchart of a withdrawal request, according to some embodiments. In some embodiments, the transaction memory management module may receive a request for an intended withdrawal from the account (block 1120). In response to this request, a transaction management module may calculate an amount of a total withdrawal to provide an intended withdrawal amount to a recipient of the intended withdrawal (block 1122). In such an embodiment, the intended recipient may be the transaction recipient. Additionally, the transaction management module may also calculate the amount of the total withdrawal to provide an agreed percentage of the total withdrawal to the secondary recipient such that the payment to the secondary recipient includes the payment portion allocated to a return of capital and the other payment portion allocated to an agreed royalty payment (block 1122). Then, in order to facilitate the payment, the transaction management module may pay the agreed percentage to the secondary recipient (block 1124).

In another example, FIG. 10D, illustrates a high-level logical flowchart of a deposit request, according to some embodiments. A transaction management module may receive a request for an intended deposit to the account. In order to calculate the division of funds between the transaction recipient and the secondary recipient (block 1130), the transaction management module may calculate an amount of a net deposit to the account and an amount of payment to the secondary recipient such that the payment portion to the secondary recipient includes the payment portion allocated to a return of capital and the other payment portion allocated to an agreed royalty payment (block 1132). The transaction management module may then pay the calculated amount of payment to the secondary recipient (block 1134).

In some other embodiments, to calculate the division of funds (block 1102), a transaction management module may utilize payment determination data. For example, in some embodiments, a transaction management module may receive payment determination data. When calculating the division of funds between a transaction recipient and a secondary recipient based, at least in part, on the payment obligation attached to the account, the transaction management module may determine an amount of a current payment based at least in part upon an amount of previous payments to the secondary recipient.

Referring back to FIG. 10A, the transaction management module may then facilitate payment to the secondary recipient (block 1104). The payment may include a payment portion allocated to a return of capital and another payment allocated to an agreed royalty payment. Note, that the above flowcharts are given for illustrative purposes only, and as such may not be construed as to be limiting as to a particular ordering of operations according to the blocks as depicted.

FIG. 10B illustrates a high-level logical flowchart of operations that can be used in conjunction with an account in some embodiments. Similar to FIG. 10A discussed above, in some embodiments, a transaction management module, such as transaction management module 220 described above with regard to FIG. 1, or other module or component implementing the operations illustrated in FIG. 10B, may receive a request for a transaction on an account (block 1110). The transaction management module may then calculate the payment obligation (block 1112). Based, at least in part the calculated payment obligation attached to the account, the transaction management module may calculate a division of funds between a transaction recipient and a secondary recipient (block 1114), implementing the various methods and techniques discussed above with regard to block 1102 in FIG. 10A. The transaction management module may then facilitate payment the secondary recipient (block 1116), implementing the various methods and techniques discussed above with regard to block 1104 in FIG. 10A.

Many different implementations of calculating the payment obligation may be implemented, for instance with regard to a particular asset or agreement. For example, in some embodiments, a transaction management module may allocate a payment portion to a return of capital and allocate another payment portion to an agreed patent royalty payment. In another example, in at least some embodiments, a transaction management module may calculate a value or set of values of a payment or a series of payments under a contract for an advance capital an license of intellectual property.

The type of payment obligation may, for example, influence facilitating payment to the secondary recipient. For instance, in some embodiments the payment obligation may be a series of payments. In such embodiments, the transaction management module may apply a first group of payments from the series of payments entirely toward the return of capital until retirement and apply a second group of payments from the series of payments entirely toward the agreed royalty payment. As different variations may exist in the grouping or number of series of payments, the above example is not intended to be limiting.

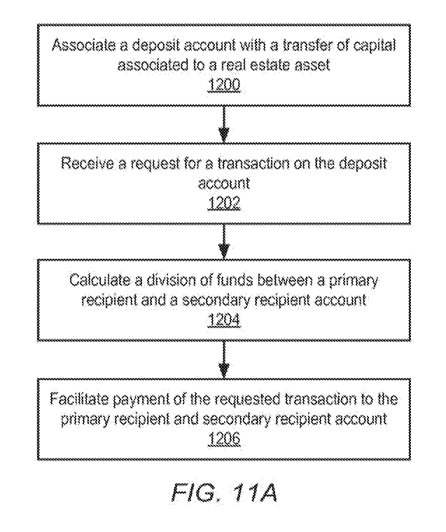

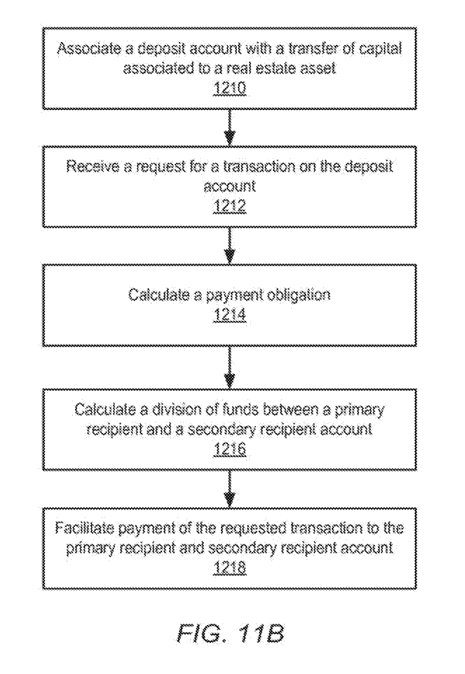

FIG. 11A illustrates a high-level logical flowchart of operations that can be used in conjunction with an account in some embodiments. In some embodiments, a transaction management module, such as transaction management module 220 described above with regard to FIG. 1, or other module or component implementing the operations illustrated in FIG. 11A, may associate a deposit account with a transfer of capital associated to a real estate asset (block 1200). The transaction management module may also receive a request for a transaction on the associated deposit account (block 1202). In response to the request for the transaction on the deposit account, the transaction management module may calculate a division of funds between a primary recipient account, such as primary recipient 610 described above with regard to FIG. 6A, and a secondary recipient account, such as secondary recipient 606 described above with regard to FIG. 6A (block 1204). This calculation of the division of funds may be based, at least in part, on a payment obligation attached to the deposit account with respect to the transfer of capital. In some embodiments, the transaction management module may also calculate the payment obligation, such as illustrated in FIG. 10B. However, in at least some embodiments, the transaction management module may implement the operations depicted in FIG. 10A. The transaction management module may then facilitate payment of the requested transaction to the primary recipient account and the secondary recipient account (block 1206).

### Example System

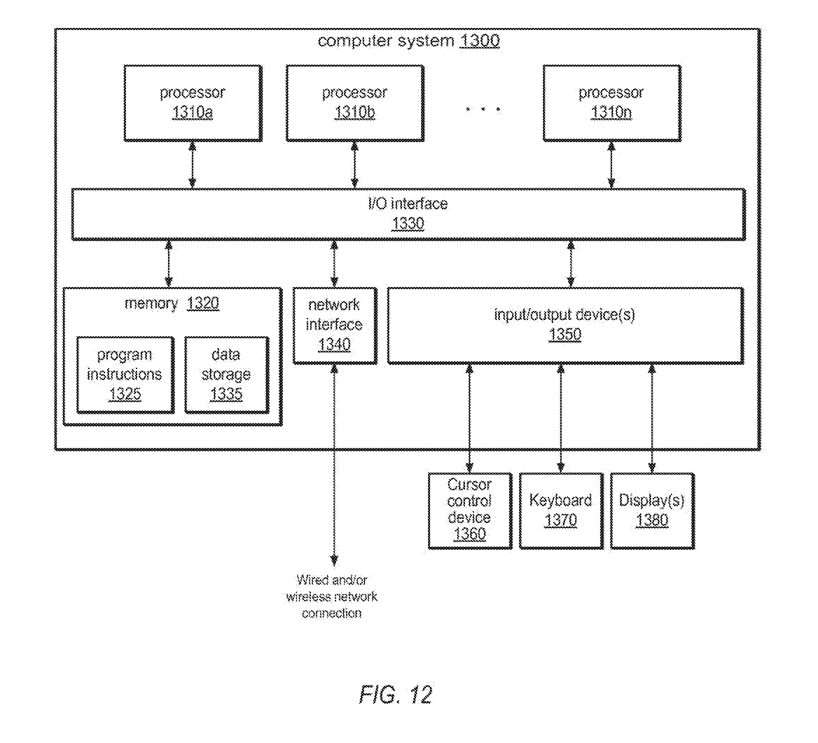

Embodiments of a system and method for tracking, managing and reporting transactions as described herein may be executed on one or more computer systems, which may interact with various other devices. One such computer system is illustrated by FIG. 12. In different embodiments, computer system 1300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1300 includes one or more processors 1310 coupled to a system memory 1320 via an input/output (I/O) interface 1330. Computer system 1300 further includes a network interface 1340 coupled to I/O interface 1330, and one or more input/output devices 1350, such as cursor control device 1360, keyboard 1370, and display(s) 1380. In some embodiments, it is contemplated that embodiments may be implemented using a single instance of computer system 1300, while in other embodiments multiple such systems, or multiple nodes making up computer system 1300, may be configured to host different portions or instances of embodiments. For example, in one embodiment some elements may be implemented via one or more nodes of computer system 1300 that are distinct from those nodes implementing other elements.

In various embodiments, computer system 1300 may be a uniprocessor system including one processor 1310, or a multiprocessor system including several processors 1310 (e.g., two, four, eight, or another suitable number). Processors 1310 may be any suitable processor capable of executing instructions. For example, in various embodiments, processors 1310 may be general-purpose or embedded processors implementing any of a variety of instruction set architectures (ISAs), such as the x86, PowerPC, SPARC, or MIPS ISAs, or any other suitable ISA. In multiprocessor systems, each of processors 1310 may commonly, but not necessarily, implement the same ISA.

System memory 1320 may be configured to store program instructions and/or data accessible by processor 1310. In various embodiments, system memory 1320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a transaction management module are shown stored within system memory 1320 as program instructions 1325 and data storage 1335, respectively. In other embodiments, program instructions and/or data may be received, sent or stored upon different types of computer-accessible media or on similar media separate from system memory 1320 or computer system 1300. Generally speaking, a computer-accessible medium may include storage media or memory media such as magnetic or optical media, e.g., disk or CD/DVD-ROM coupled to computer system 1300 via I/O interface 1330. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1340.

In one embodiment, I/O interface 1330 may be configured to coordinate I/O traffic between processor 1310, system memory 1320, and any peripheral devices in the device, including network interface 1340 or other peripheral interfaces, such as input/output devices 1350. In some embodiments, I/O interface 1330 may perform any necessary protocol, timing or other data transformations to convert data signals from one component (e.g., system memory 1320) into a format suitable for use by another component (e.g., processor 1310). In some embodiments, I/O interface 1330 may include support for devices attached through various types of peripheral buses, such as a variant of the Peripheral Component Interconnect (PCI) bus standard or the Universal Serial Bus (USB) standard, for example. In some embodiments, the function of I/O interface 1330 may be split into two or more separate components, such as a north bridge and a south bridge, for example. In addition, in some embodiments some or all of the functionality of I/O interface 1330, such as an interface to system memory 1320, may be incorporated directly into processor 1310.

Network interface 1340 may be configured to allow data to be exchanged between computer system 1300 and other devices attached to a network, such as other computer systems, or between nodes of computer system 1300. In various embodiments, network interface 1340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1350 may, in some embodiments, include one or more display terminals, keyboards, keypads, touchpads, scanning devices, voice or optical recognition devices, or any other devices suitable for entering or retrieving data by one or more computer system 1300. Multiple input/output devices 1350 may be present in computer system 1300 or may be distributed on various nodes of computer system 1300. In some embodiments, similar input/output devices may be separate from computer system 1300 and may interact with one or more nodes of computer system 1300 through a wired or wireless connection, such as over network interface 1340.

As shown in FIG. 12, memory 1320 may include program instructions 1325, configured to implement embodiments of a transaction management module as described herein, and data storage 1335, comprising various data accessible by program instructions 1325. In one embodiment, program instructions 1325 may include software elements of embodiments of a transaction management module as illustrated in the above Figures. Data storage 1335 may include data that may be used in embodiments. In other embodiments, other or different software elements and data may be included.

Those skilled in the art will appreciate that computer system 1300 is merely illustrative and is not intended to limit the scope of a transaction management module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1300 may be transmitted to computer system 1300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
in response to a transaction on an account that is a single transaction that includes revenue, comparing, via a one or more processors, transaction data for the transaction to an algorithmic representation of an agreement between a transaction recipient and one or more parties of the agreement that supports a revenue allocation based on a determination if a payment obligation is applicable to the transaction based on the revenue, based on a date of the transaction, and further based on historical data for the account;
responsive to determining that the payment obligation is applicable to the transaction, calculating, via the one or more processors, an allocation of funds based on the algorithmic representation of the agreement between the transaction recipient and the one or more parties of the agreement;
storing a record of the allocation of funds on a storage device; and
automatically processing a payment, via the one or more processors, to the one or more parties of the agreement, in accordance with the record of the allocation of funds.

2. The method of claim 1, wherein calculating the allocation of funds based on the algorithmic representation of the agreement between the transaction recipient and the one or more parties of the agreement further comprises calculating a payment portion allocated to a return of capital, and another payment portion allocated to an agreed royalty payment.

3. The method of claim 1, wherein calculating the allocation of funds based on the algorithmic representation of the agreement between the transaction recipient and the one or more parties of the agreement further comprises calculating the allocation of funds based on the algorithmic representation of the agreement between the transaction recipient and the one or more parties of the agreement based at least in part on the date of the transaction.

4. The method of claim 1, wherein calculating the allocation of funds based on the algorithmic representation of the agreement between the transaction recipient and the one or more parties of the agreement further comprises calculating the allocation of funds based on the algorithmic representation of the agreement between the transaction recipient and the one or more parties of the agreement based at least in part on a percentage allocation of the transaction reflected in the algorithmic representation of the agreement between the transaction recipient and the one or more parties of the agreement.

5. The method of claim 1, wherein calculating the allocation of funds based on the algorithmic representation of the agreement between the transaction recipient and the one or more parties of the agreement further comprises calculating the allocation of funds based on the algorithmic representation of the agreement between the transaction recipient and the one or more parties of the agreement based at least in part on an amount of the transaction.

6. The method of claim 1, wherein the comparing the transaction data for the transaction to one or more transaction rules further comprises comparing transaction data for the transaction and the historical data for the account to one or more transaction rules.

7. The method of claim 1, further comprising generating a report based on the allocation of funds, wherein the report provides instructions for performing a payment.

8. A system, comprising:
at least one processor; and
a memory comprising program instructions, wherein the program instructions are executable by the at least one processor to:
in response to a transaction on an account that is a single transaction that includes revenue, comparing, via a one or more processors, transaction data for the transaction to an algorithmic representation of an agreement between a transaction recipient and one or more parties of the agreement that supports a revenue allocation based on a determination if a payment obligation is applicable to the transaction based on the revenue, based on a date of the transaction, and further based on historical data for the account;
responsive to determining that the payment obligation is applicable to the transaction, calculate an allocation of funds based on the algorithmic representation of the agreement between the transaction recipient and the one or more parties of the agreement;
store a record of the allocation of funds on a storage device; and
automatically processing a payment to the one or more parties of the agreement, in accordance with the record of the allocation of funds.

9. The system of claim 8, wherein the program instructions executable by the at least one processor to calculate the allocation of funds based on the algorithmic representation of the agreement between the transaction recipient and the one or more parties of the agreement further comprise program instructions executable by the at least one processor to calculate a payment portion allocated to a return of capital, and another payment portion allocated to an agreed royalty payment.

10. The system of claim 8, wherein the program instructions executable by the at least one processor to calculate the allocation of funds based on the algorithmic representation of the agreement between the transaction recipient and the one or more parties of the agreement further comprise program instructions executable by the at least one processor to calculate the allocation of funds based on the algorithmic representation of the agreement between the transaction recipient and the one or more parties of the agreement based at least in part on the date of the transaction.

11. The system of claim 8, wherein the program instructions executable by the at least one processor to calculate the allocation of funds based on the algorithmic representation of the agreement between the transaction recipient and the one or more parties of the agreement further comprise program instructions executable by the at least one processor to calculate the allocation of funds based on the algorithmic representation of the agreement between the transaction recipient and the one or more parties of the agreement based at least in part on a percentage allocation of the transaction reflected in the algorithmic representation of the agreement between the transaction recipient and the one or more parties of the agreement.

12. The system of claim 8, wherein the program instructions executable by the at least one processor to calculate the allocation of funds based on the algorithmic representation of the agreement between the transaction recipient and the one or more parties of the agreement further comprise program instructions executable by the at least one processor to calculating the allocation of funds based on the algorithmic representation of the agreement between the transaction recipient and the one or more parties of the agreement based at least in part on an amount of the transaction.

13. The system of claim 8, wherein the program instructions executable by the at least one processor to compare transaction data for the transaction to one or more transaction rules further comprise program instructions executable by the at least one processor to compare transaction data for the transaction and the historical data for the account to one or more transaction rules.

14. The system of claim 8, further comprising program instructions executable by the at least one processor to generate a report based on the allocation of funds, wherein the report provides instructions for performing a payment.

15. An apparatus comprising:
means, in response to a transaction on an account that is a single transaction that includes revenue, for comparing transaction data for the transaction to an algorithmic representation of an agreement between a transaction recipient and one or more parties of the agreement that supports a revenue allocation based on a determination if a payment obligation is applicable to the transaction based on the revenue, based on a date of the transaction, and further based on historical data for the account;
means, responsive to determining that the payment obligation is applicable to the transaction, for calculating an allocation of funds based on the algorithmic representation of the agreement between the transaction recipient and the one or more parties of the agreement;
means for storing a record of the allocation of funds on a storage device; and
means for automatically processing a payment to the one or more parties of the agreement, in accordance with the record of the allocation of funds.

16. The apparatus of claim 15 further comprising: means for calculating a payment portion allocated to a return of capital, and another payment portion allocated to an agreed royalty payment.

17. The apparatus of claim 15 further comprising: means for calculating the allocation of funds based on the algorithmic representation of the agreement between the transaction recipient and the one or more parties of the agreement based at least in part on the date of the transaction.

18. The apparatus of claim 15 further comprising: means for calculating the allocation of funds based on the algorithmic representation of the agreement between the transaction recipient and the one or more parties of the agreement based at least in part on a percentage allocation of the transaction reflected in the algorithmic representation of the agreement between the transaction recipient and the one or more parties of the agreement.

19. The apparatus of claim 15 further comprising: means for calculating the allocation of funds based on the algorithmic representation of the agreement between the transaction recipient and the one or more parties of the agreement based at least in part on an amount of the transaction.

20. The apparatus of claim 15 further comprising: means for comparing transaction data for the transaction and the historical data for the account to one or more transaction rules.
